(19) United States
(12) Patent Application Publication
(10) Pub. No.: US 2025/0022009 A1
(43) Pub. Date: Jan. 16, 2025

(54) METHOD FOR OPTIMIZING AD CAMPAIGNS BY GENERATING AUDIENCE COHORTS OF iOS USERS

(71) Applicant: AIQUIRE INC., Chicago, IL (US)

(72) Inventors: Vrushali PRASADE, Bengaluru (IN); Satyam VIVEK, Bengaluru (IN); Shubham MISHRA, Bengaluru (IN)

(73) Assignee: AIQUIRE INC., Chicago, IL (US)

(21) Appl. No.: 18/713,097

(22) PCT Filed: Nov. 22, 2022
(86) PCT No.: PCT/US2022/050781

§ 371 Date: May 23, 2024

(30) Foreign Application Priority Data
Nov. 23, 2021 (IN) 202141054028

(51) Int. Cl. G06Q 30/0242; G06Q 30/0251

(52) U.S. Cl. CPC G06Q 30/0244; G06Q 30/0251

(57) ABSTRACT

The present disclosure provides a method for optimizing ad campaigns of iOS users. The method comprises collecting (201) data input from data sources, by a data module, generating (202) audience cohorts based on the data input, by an audience cohort generation module, ranking (203) the audience cohorts based on parameters, by a cohort ranking module, generating (204) clusters of ad sets based on similar targeting, by ad publishing module, assigning (205) a confidence metric to the cluster based on performance of the ad set, by the ad publishing module, enabling and/or disabling (206) ad sets based on confidence metric, by the ad publishing module, analyzing (207) performance of the ad sets and transmitting feedback of the performance to an artificial intelligence module, by a social media platform and attribution platform and optimizing (208) performance of the ad sets based on the feedback of the performance, by the artificial intelligence module.

### FIELD

The embodiments herein generally relate to optimizing ad campaigns. More particularly, the disclosure relates to a method for optimizing ad campaigns by audience cohorts of iOS users.

### BACKGROUND AND PRIOR ART

Online businesses use ad campaigns as a tool for expanding and improving their business and reach. These Ad campaigns are optimized for achieving the desired results by determining the right target audience, keywords and estimating the corresponding bid and budget.

However, the methods of automating these ad campaigns rely on social media platforms that track user engagement in the platform and outside the platform for receiving data, and improvising and optimizing the parameters of the ad campaigns based on the data. The social media platforms provide tracking and reporting tools and parameters for tracking user engagement, thereby assisting in finding the target audience and measuring success of the ad campaigns.

These methods of optimizing ad campaigns are completely dependent on the data received from the social media platforms for optimization, and the methods cannot optimize the ad campaigns without access to the data. Optimization of ad campaigns is necessary to online businesses for irrespective of receiving data from these social media sources.

Therefore, there is a need for automated optimization of ad campaigns independent of receiving data from social media platforms. Moreover, there is a need for a method of optimizing ad campaigns by generating audience cohorts of iOS users independently.

### OBJECTS

Some of the objects of the present disclosure are described herein below:

The main objective of the present disclosure is to provide a method for optimizing ad campaigns independent of data from social media platforms.

Another objective of the present disclosure is to provide a method for generating audience cohorts of iOS users.

Still another objective of the present disclosure is to provide a method for automating optimization of ad campaigns using artificial intelligence.

Yet another objective of the present disclosure is to provide a method for real-time optimization of ad campaigns independent of data from social media platforms.

The other objectives and advantages of the present disclosure will be apparent from the following description when read in conjunction with the accompanying drawings, which are incorporated for illustration of preferred embodiments of the present disclosure and are not intended to limit the scope thereof.

### SUMMARY

In view of the foregoing, an embodiment herein provides a method for optimizing ad campaigns by generating audience cohorts of iOS users.

In accordance with an embodiment, the method comprises the following steps. First, collecting data input from a plurality of data sources, by a data module, then generating audience cohorts based on the data input, by an audience cohort generation module, next ranking the audience cohorts based on factors, by a cohort ranking module, then generating clusters of ad sets based on similar targeting, by ad publishing module, assigning a confidence metric to the cluster based on performance of the ad set, by the ad publishing module, enabling and disabling ad sets based on confidence metric of the cluster, by the ad publishing module, analyzing performance of the ad sets and transmitting feedback of the performance to an artificial intelligence module, by a social media platform and attribution platform and optimizing performance of the ad sets based on the feedback of the performance, by the artificial intelligence module.

In accordance with an embodiment, the data input including audience data collected from a first-party data source, web traffic data collected from analytics aggregators, web analytics collected from web analytics tools, search trends collected from online advertising platforms and performance of previous ads collected from social media marketing platforms.

In accordance with an embodiment, generating audience cohorts including accumulating keywords based on details of brand name, website, keywords, industry, price range provided by a user, semantic mapping of the keywords with objectives of ad campaigns, clustering keywords based on factors of brand, interest, search volume and meaning and generating audience cohorts by segmenting the data input of target audience and mapping with the clusters.

In accordance with an embodiment, parameters of ranking the audience cohorts including relevance, audience size, projected and performance.

In accordance with an embodiment, assigning confidence metric including analyzing performance of one ad set from each cluster and assigning a confidence metric to the cluster of the ad set based on the performance of the ad set.

In accordance with an embodiment, optimizing performance by the artificial intelligence including granular targeting for dividing the target audience and generating multiple ad groups corresponding to the smaller group of target audience and identifying right target audience based on user engagement data of each of the ad groups.

In accordance with an embodiment, optimizing performance by the artificial intelligence including CRM integration for tracking web events and conversions and mapping the data received from the CRM integration by a semantic mapping system with the audience cohorts and ad groups.

In accordance with an embodiment, enabling and disabling ad sets including enabling the ad set in the cluster with higher confidence metric and disabling the ad set in the cluster with lower confidence metric.

In accordance with an embodiment, analyzing performance includes collecting data from ad campaigns with the enabled ad sets from in-app engagements of social media platforms and attribution platforms on ad set level and ads level.

In accordance with an embodiment, optimizing performance includes optimizing targeting based on factors of age, gender, interest, behavior, demographic and location.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1a illustrates a schematic of a system for optimizing ad campaigns by generating audience cohorts of iOS users, according to an embodiment herein;

FIG. 1b illustrates a schematic of functions of the system for optimizing ad campaigns by generating audience cohorts of iOS users, according to an embodiment herein;

FIG. 2 illustrates a flowchart of a method for optimizing ad campaigns by generating audience cohorts of iOS users, according to an embodiment herein; and

FIG. 3 illustrates a schematic of optimizing performance by the artificial intelligence module, according to an embodiment herein

### LIST OF NUMERALS

101—Data input module
102—Audience cohort generation module
103—Cohort ranking module
104—Ad publishing module
105—Ad network
106—Artificial intelligence module

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

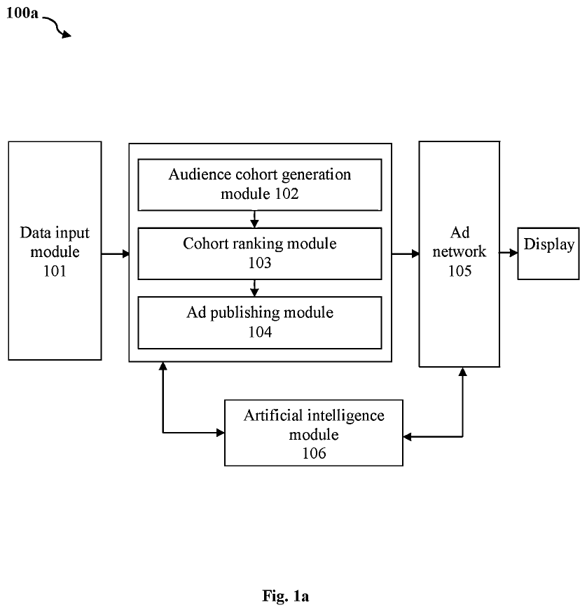

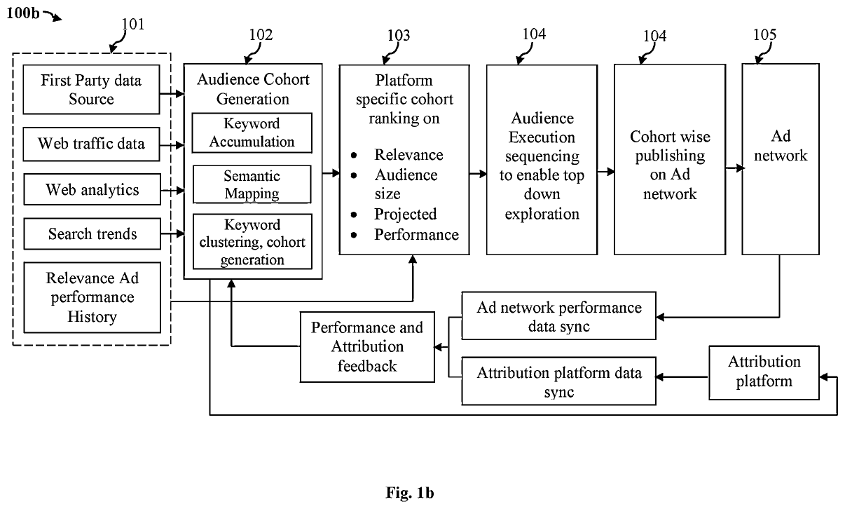

As mentioned above, there is a need for automated optimization of ad campaigns independent of receiving data from social media platforms. In particular, there is a need for a method of optimizing ad campaigns by generating audience cohorts of iOS users independently. The embodiments herein achieve this by providing “A method for optimizing ad campaigns by generating audience cohorts of iOS users”. Referring now to the drawings, and more particularly to FIG. 1 through FIG. 3, where similar reference characters denote corresponding features consistently throughout the figures, there are shown preferred embodiments.

FIG. 1 illustrates a schematic of a system for optimizing ad campaigns by generating audience cohorts of iOS users. In an embodiment, the system includes a data input module 101, an audience cohort generation module 102, cohort ranking module 103, ad publishing module 104 and an artificial intelligence module 106.

In an embodiment, the data input module 101 is provided for collecting data from data sources for data input. In an embodiment, the data including but not limited to audience data, web traffic data, web analytics, search trends and performance history of previous relevant ads. In an embodiment, the data sources including but not limited to first-party data source such as similar web, semrush for collecting the audience data, analytics aggregators such as google analytics for collecting website traffic data, web analytics tools for collecting web analytics, online advertising platforms such as google ad words for collecting the current search trends and social media marketing platforms such as facebook ads for collecting the performance history of previous relevant ads. The data collected from the data sources is transmitted as data input to the audience cohort generation module 102.

In an embodiment, the audience cohort generation module 102 is provided for generating audience cohorts. Audience cohort generation includes accumulating keywords based on details provided by a user. In an embodiment, the details including but not limited to brand name, website, keywords, industry segment to which the brand belongs, details of analytics platforms such as google analytics id, price range of products. Next, the keywords are mapped with requirement of user and objective of campaigns. Then, the keywords are clustered and labeled based on factors including but not limited to brand, interest, search volume and meaning. The data input received from the data input module 101 including the audience are segmented in the clusters for generating audience cohorts. The audience cohorts are mapped with keyword clusters based on relevance scores and transmitted to the cohort ranking module 103.

In an embodiment, the cohort ranking module 103 is provided for ranking the audience cohorts based on factors including but not limited to relevance, audience size, projected, and performance. The ranked audience cohorts are transmitted to the Ad publishing module 104.

In an embodiment, the Ad publishing module 104 is provided for optimizing the ad campaign. Based on audience cohorts and keywords of ad sets, the ad publishing module 104 clusters the ad sets having similar targeting. One ad set from each cluster is taken for assessing the performance, and based on the performance a confidence metric is assigned to the cluster of the ad sets. The ad sets from clusters having low confidence metric are disabled and ad sets from clusters having high confidence metric are enabled.

In an embodiment, the ad campaigns with enabled ad sets are published in the ad network 105. Performance of the ad campaigns are monitored using social media platform and attribution platforms on ad set level and ads level. The monitored data is transmitted as a feedback to the artificial intelligence module 106.

In an embodiment, the artificial intelligence module 106 is provided for optimizing bid and budget of the ad campaign.

FIG. 1b illustrates a schematic of functions performed by the system for optimizing ad campaigns by generating audience cohorts, as described in FIG. 1.

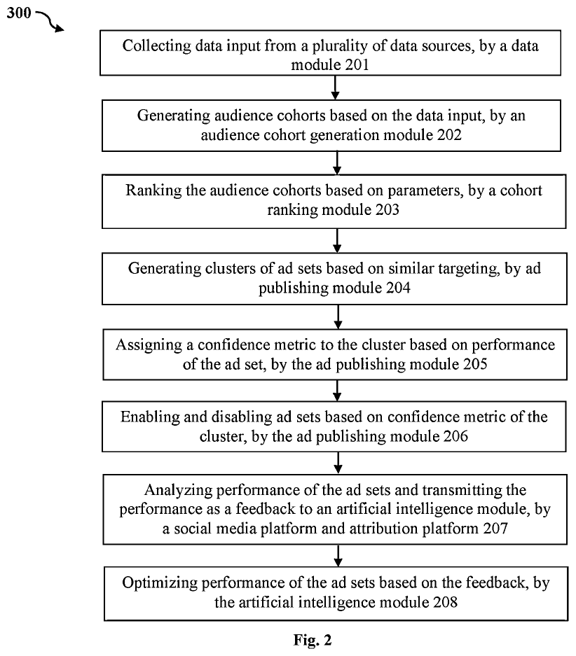

FIG. 2 illustrates a flow chart of a method for optimizing ad campaigns by generating audience cohorts of iOS users. In an embodiment, the method includes the following steps. First, collecting 201 data input from a plurality of data source, by the data module. The data input includes but not limited to data input including audience data collected from a first-party data source, web traffic data collected from analytics aggregators, web analytics collected from web analytics tools, search trends collected from online advertising platforms and performance of previous ads collected from social media marketing platforms. Next, generating 202 audience cohorts based on the data input, by the audience cohort generation module. In an embodiment, generating audience cohorts includes accumulating keywords based on details of brand name, website, keywords, industry, price range provided by a user, data fetched from data providers and internal data.

The data providers including website analytics data provider such as Google Analytics, competitor list data provider such as SEMrush, search keywords data provider such as Google Adwords and target audience data provider such as facebook interest API. Internal data includes data about the user including but not limited to advertising campaigns and previously collected data from the data providers. Next, semantic mapping of the keywords with objectives of ad campaigns. The accumulated keywords are mapped with requirements of the user and objectives of the ad campaigns planned by the user. Then, clustering the keywords based on factors of brand, interest, search volume and meaning and the clusters of the keywords are labeled. Next, generating audience cohorts by segmenting the data input of target audience and mapping with the clusters of the keywords. The audience cohorts are mapped with the keyword clusters based on relevance score.

Next, ranking 203 the audience cohorts based on parameters, by the cohort ranking module. In an embodiment, ranking of the audience cohorts is based on factors including but not limited to relevance, audience size, projected and performance.

Then, generating 204 clusters of ad sets based on similar targeting, by the ad publishing module. Ad sets are generated based on the audience cohorts and the clusters of keywords. Clusters of the ad sets are generated based on similar targeting parameters of target audience.

Next, assigning a confidence metric to the cluster based on performance of the ad set, by the ad publishing module. Confidence metric is assigned to the cluster by analyzing performance of one ad set from each cluster and based on the performance, assigning a confidence metric to the cluster of the ad set.

Then, enabling and disabling 206 ad sets based on confidence metric of the cluster, by the ad publishing module. In an embodiment, enabling ad sets from clusters with higher confidence metric and disabling ad sets from clusters with lower confidence metric.

Next, analyzing 207 performance of the ad sets and transmitting the performance as a feedback to an artificial intelligence module, by a social media platform and attribution platform. Analyzing performance includes collecting data from the live ad campaigns with the enabled ad sets from in-app engagements of social media platforms and attribution platforms on ad set level and ads level. The analyzed performance is transmitted as a feedback to the artificial intelligence module.

Then, optimizing 208 performance of the ad sets based on the feedback, by the artificial intelligence module. The artificial intelligence module optimizes bid, budget and targeting of the ad campaign based on the feedback.

Next, optimizing performance by the artificial intelligence module including granular targeting and tightly coupled CRM (Customer relationship management) integration. The optimization is performed based on factors of age, gender, interest, behavior, demographic and location.

In an embodiment, granular targeting includes dividing the target audience and generating multiple ad groups corresponding to the smaller group of target audience. The artificial intelligence module identifies right target audience based on user engagement data of each of the ad groups. Thereby the artificial intelligence module optimizes increasing and decreasing bids and budget of the ad campaigns based on user engagements and performance of the ad groups. The granular targeting identifies right target audience and optimizes the ad campaign independent of data from social media platforms.

In an embodiment, the CRM integration is integrated with artificial intelligence module for tracking web events and conversions. The data received from the CRM integration is mapped by a semantic mapping system with the audience cohort and the ad groups. The mapping of the data and in-app user engagement with social media platforms is transmitted to a bid and budget optimization system.

In an embodiment, the bid and budget optimization is performed by a bandit based approach. In an embodiment, the bandit-based approach includes contextual bandit approach and multi-arm bandit approach. The bandit-based approach including creating new arms (actions) according to new bandit settings, wherein the new bandit setting based on optimization of bids or budgets, minimum and maximum values of metrics, and number of arms.

The bandit-based approach includes KL-Upper Confidence Bound. Actions of the optimization of ad campaigns are maintained for giving higher rewards to arm/bandits which gave a better performance in older iterations.

$${μ}_{t} = {μ}_{t - 1} + √ ( ( 2 / N ) log ( 1 / δ ) ) ;$$

wherein, μₜ, μₜ₋₁ refers to mean reward;
N refers to number of trials for the arm; and
δ refers to confidence.

In an embodiment, arm with maximum mean reward value is selected such that for all other actions:

Number of trials of the arm a*(divergence(no. of successes/Number of trials of the arm a,Mean Reward)<log(t);

wherein, ‘t’ is the current time step.

In an embodiment, the bid and budget optimization module receives the optimization from the multi arm bandit approach and contextual bandit approach, predicts performance of the ad campaign based on the rule based approach and the bandit based approach. Based on the predicted performance, the bid and budget optimization module determines a confidence score to the optimization using rule based approach and optimization using bandit based approach. The bid and budget optimization module selects the optimization with the highest confidence score for automated optimization of the ad campaign.

In an embodiment, the artificial intelligence module includes a performance optimization module for campaign budget optimization. The performance optimization module includes a heuristic system and a budget reallocation system.

In an embodiment, the heuristic system is threshold based, wherein actions are performed based on calculated scores in scores tables and pre-configured rules. The pre-configured rules determine at what combination of rates it is recommended to perform actions. If the combination of scores in the campaign matches the combination in the action, the action is provided as a recommendation.

In an embodiment, the actions include but not limited to increasing/decreasing ad set bid, increasing/decreasing ad set budget, creative refresh, turning off the ad campaign.

In an embodiment, the budget reallocation system includes target CPR (Cost per rating points) and target results for the ad campaign. Target results per ad-set is obtained by Target result/No. of Adsets. The target CPR remains consistent across the adsets which is equal to the target CPR

Performance cost score is calculated by Target CPR/Actual CPR and ideal budget is obtained based on:

Actual Results*Target CPR*Target Results/Sum(Actual Results)

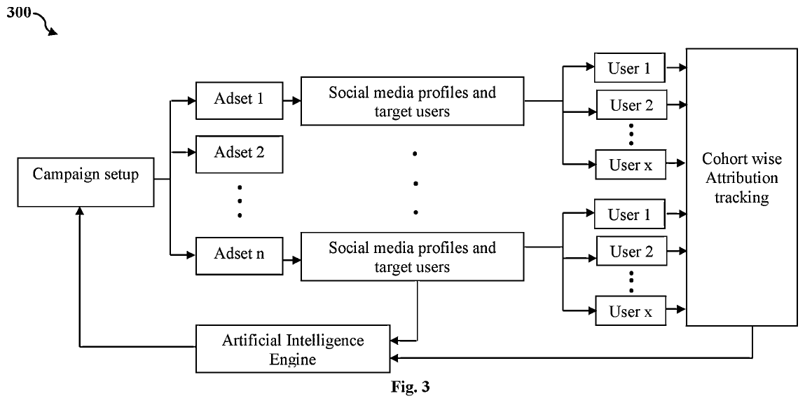

FIG. 3 illustrates a schematic of optimizing performance by the artificial intelligence module. In an embodiment, the ad campaign is divided into plurality of ad sets, each ad campaign including a small group of target audience. User engagement of the target audience is tracked by the CRM by cohort wise attribution tracking. The tracking data is transmitted to the artificial intelligence engine for optimizing the campaign setup.

A main advantage of the present disclosure is that the method provides optimizing ad campaigns independent of receiving data from social media platforms.

Another advantage of the present disclosure is that the method provides optimizing ad campaigns by generating audience cohorts of iOS users.

Still another advantage of the present disclosure is that the method provides automated optimization of ad campaigns without relying on external social media platforms.

Yet another advantage of the present disclosure is that the method provides an efficient, accurate and faster method of optimizing ad campaigns using artificial intelligence.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for optimizing ad campaigns by generating audience cohorts of iOS users, comprising the steps of:
collecting (201) data input from a plurality of data sources, by a data module;
generating (202) audience cohorts based on the data input, by an audience cohort generation module;
ranking (203) the audience cohorts based on factors, by a cohort ranking module;
generating (204) clusters of ad sets based on similar targeting, by ad publishing module;
assigning (205) a confidence metric to the cluster based on performance of the ad set, by the ad publishing module;
enabling and disabling (206) ad sets based on confidence metric of the cluster, by the ad publishing module;
analyzing (207) performance of the ad sets and transmitting feedback of the performance to an artificial intelligence module, by a social media platform and attribution platform; and
optimizing (208) performance of the ad sets based on the feedback of the performance, by the artificial intelligence module.

2. The method as claimed in claim 1, wherein the data input including audience data collected from a first-party data source, web traffic data collected from analytics aggregators, web analytics collected from web analytics tools, search trends collected from online advertising platforms and performance of previous ads collected from social media marketing platforms.

3. The method as claimed in claim 1, wherein generating audience cohorts including:
accumulating keywords based on details of brand name, website, keywords, industry, price range provided by a user;
semantic mapping of the keywords with objectives of ad campaigns;
clustering keywords based on factors of brand, interest, search volume and meaning; and
generating audience cohorts by segmenting the data input of target audience and mapping with the clusters.

4. The method as claimed in claim 1, wherein factors of ranking the audience cohorts including relevance, audience size, projected and performance.

5. The method as claimed in claim 1, wherein assigning confidence metric including analyzing performance of one ad set from each cluster and assigning a confidence metric to the cluster of the ad set based on the performance of the ad set.

6. The method as claimed in claim 1, wherein optimizing performance by the artificial intelligence including granular targeting for dividing the target audience and generating multiple ad groups corresponding to the smaller group of target audience; and
identifying right target audience based on user engagement data of each of the ad groups.

7. The method as claimed in claim 1, wherein optimizing performance by the artificial intelligence including CRM integration for tracking web events and conversions; and
mapping the data received from the CRM integration by a semantic mapping system with the audience cohorts and ad groups.

8. The method as claimed in claim 1, wherein enabling and disabling ad sets including enabling the ad set in the cluster with higher confidence metric and disabling the ad set in the cluster with lower confidence metric.

9. The method as claimed in claim 1, wherein analyzing performance includes collecting data from ad campaigns with the enabled ad sets from in-app engagements of social media platforms and attribution platforms on ad set level and ads level.

10. The method as claimed in claim 1, wherein optimizing performance includes optimizing targeting based on factors of age, gender, interest, behavior, demographic and location.
